(19) United States
(12) Patent Application Publication
(10) Pub. No.: US 2026/0052597 A1
(43) Pub. Date: Feb. 19, 2026

(54) EFFICIENT RESOURCE GRANTS FOR RADIO RESOURCE CONTROL MESSAGING

(71) Applicant: Dell Products L.P., Round Rock, TX (US)

(72) Inventor: Harn-Jier Lin, Lisle, IL (US)

(21) Appl. No.: 18/806,205

(22) Filed: Aug. 15, 2024

(51) Int. Cl. H04W 76/27; H04L 5/00; H04W 72/1263

(52) U.S. Cl. CPC H04W 76/27; H04L 5/0005; H04W 72/1263

(57) ABSTRACT

A method facilitating efficient resource grants for radio resource control (RRC) messaging includes generating, by centralized unit equipment including at least one processor, scheduling instructions for an RRC message, including embedding a resource grant request, for uplink communication resources to be allocated for an uplink message to be transmitted by a user equipment in response to the RRC message, into the scheduling instructions; generating, by the centralized unit equipment, a downlink F1 application protocol (F1AP) message including the RRC message and the scheduling instructions; and transmitting, by the centralized unit equipment, the downlink F1AP message to distributed unit equipment serving the user equipment.

### BACKGROUND

Various wireless communication systems operating according to Third Generation Partnership Project (3GPP) standards, such as the fifth generation (5G) new radio (NR) standard, can utilize a split architecture in which the functionality of the baseband unit (BBU) is split between a centralized unit (CU) and a distributed unit (DU). In a 3GPP DU/CU split architecture, the CU can communicate to the DU through an F1 application protocol (F1AP) interface. In 3GPP, the CU is responsible for radio resource control (RRC) messaging with the user equipment (UE). However, RRC messages sent by the CU in this manner are provided to the DU via the F1AP interface for subsequent transmission to the UE.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include embedding a resource grant request, for uplink communication resources to be allocated for a response message to be transmitted by a user equipment in response to a radio resource control (RRC) message, into scheduling instructions associated with the RRC message, resulting in augmented scheduling instructions. The instructions can further include generating an F1 application protocol (F1AP) message including the RRC message and the augmented scheduling instructions. The operations can also include transmitting the F1AP message to distributed unit equipment serving the user equipment.

In another implementation, a method is described herein. The method can include generating, by centralized unit equipment including at least one processor, scheduling instructions for an RRC message, including embedding a resource grant request, for uplink communication resources to be allocated for an uplink message to be transmitted by a user equipment in response to the RRC message, into the scheduling instructions. The method can additionally include generating, by the centralized unit equipment, a downlink F1AP message including the RRC message and the scheduling instructions. The method can further include transmitting, by the centralized unit equipment, the downlink F1AP message to distributed unit equipment serving the user equipment.

In an additional implementation, a non-transitory machine-readable medium is described herein that can include instructions that, when executed by at least one processor, facilitate performance of operations. The operations can include embedding, into scheduling instructions for an RRC message, a grant request for uplink communication resources allocated for a response message to be transmitted by a user device in response to the RRC message; generating an F1AP DL RRC message transfer message including the scheduling instructions and the RRC message; and transmitting the F1AP DL RRC message transfer message to distributed unit equipment serving the user device.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates efficient resource grants for radio resource control (RRC) messaging in accordance with various implementations described herein.

FIGS. 2-4 are diagrams illustrating respective messaging flows that can be utilized in connection with one or more implementations described herein.

FIGS. 5-6 are block diagrams of additional systems that facilitate efficient resource grants for RRC messaging in accordance with various implementations described herein.

FIG. 7 is a diagram depicting an example F1 application protocol (F1AP) message format that can be utilized in connection with one or more implementations described herein.

FIG. 8 is a block diagram of still another system that facilitates efficient resource grants for RRC messaging in accordance with various implementations described herein.

FIGS. 9-10 are flow diagrams of respective methods that facilitate efficient resource grants for RRC messaging in accordance with various implementations described herein.

FIG. 11 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

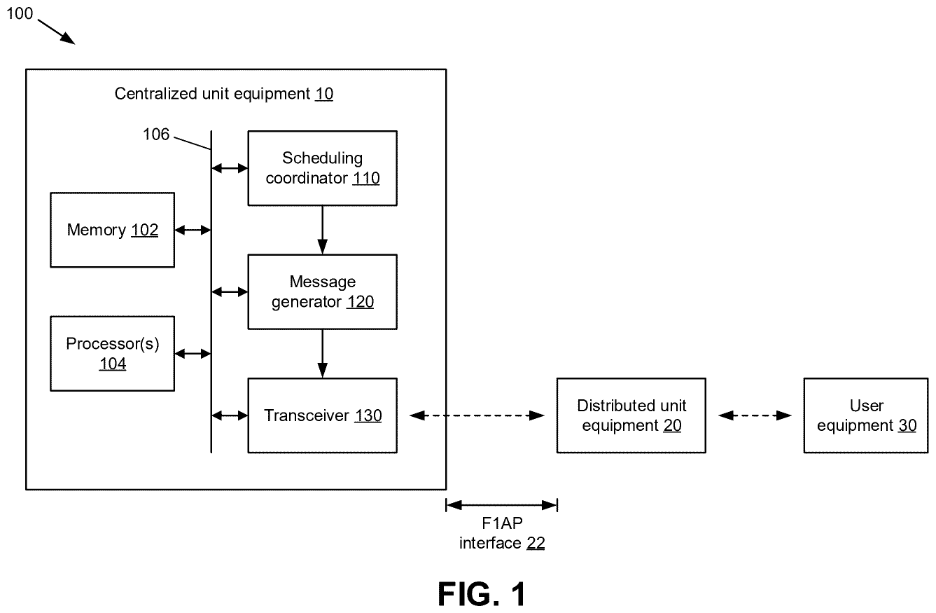

With reference to the drawings, FIG. 1 illustrates a block diagram of a system 100 that facilitates efficient resource grants for radio resource control (RRC) messaging in accordance with various implementations described herein. System 100 as shown in FIG. 1 can operate according to one or more Third Generation Partnership Project (3GPP) standards (such as fifth generation (5G) new radio (NR) or the like), which utilize a split architecture that divides functionality of a next-generation Node B (gNB), such as baseband unit (BBU) functionality or the like, into centralized unit (CU) equipment 10, also referred to herein as simply a CU 10 for brevity, and distributed unit (DU) equipment 20, also referred to herein as simply a DU 20 for brevity.

The CU/DU split architecture shown in FIG. 1 can be utilized to divide respective layers of the protocol stack among different physical units for improved efficiency and/or other benefits. For instance, the CU 10 can be responsible for processing and managing higher-layer functions, such as user mobility and connection setup, while the DU 20 can handle lower-layer functions such as baseband processing and radio resource management. Other CU/DU functionality splits could also be used.

As shown in FIG. 1, the CU 10 and DU 20 can communicate with each other via an F1 application protocol (F1AP) interface 22 and/or other suitable interfaces. Additionally, the CU 10 can control and/or otherwise be responsible for radio resource control (RRC) messaging with user equipment (UE) 30. However, due to the nature of the split architecture used by system 100, these RRC messages can go through the DU 20, which controls the lower layers of the protocol stack, via the F1AP interface 22 for transmission to the UE 30. For instance, one mechanism on the F1AP interface 22 that can be utilized for this purpose is a downlink (DL) and uplink (UL) RRC message transfer procedure, where RRC messages can be treated as a transparent container in the RRC message transfer mechanism.

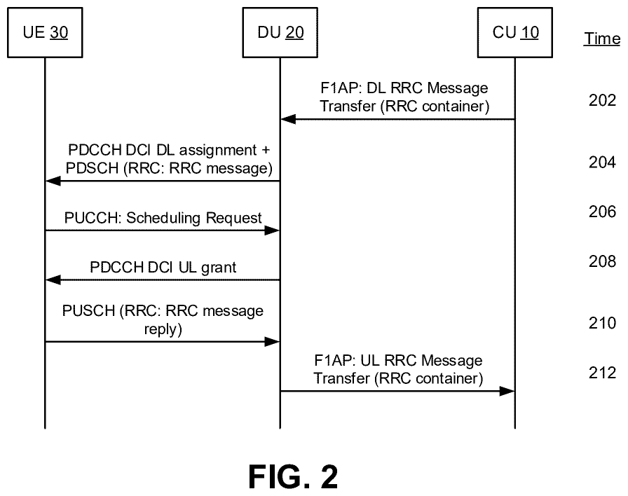

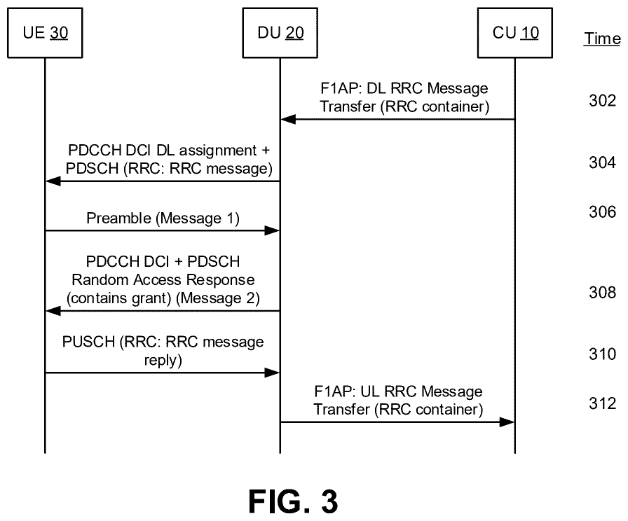

Various implementations as described herein provide for improvements to existing RRC messaging flows, e.g., to improve messaging efficiency in terms of time, frequency resources, and/or other metrics. For instance, in some RRC transactions with a UE 30, the CU 10 is configured to expect an RRC message response from the UE 30. In such cases, the conventional RRC message transfer mechanism provides two ways for the UE 30 to acquire the resources needed for sending the corresponding RRC response message. The first technique, as will be described below with respect to FIG. 2, can be used in cases where the UE 30 is configured with scheduling request functionality. In such cases, the UE 30 can send a scheduling request to the DU 20, and the DU 20 can subsequently respond with a grant to provide the UE 30 with the uplink (UL) resources for the UE 30 to send the corresponding RRC response. The second technique, as will be described below with respect to FIG. 3, can be used in cases where the UE 30 is not configured with scheduling request functionality. In this case, the UE 30 can go through a random access procedure, e.g., via a random access channel (RACH), to obtain a grant from the DU 20 for the UL resources to send the RRC response.

In both of the above techniques, the downlink (DL) message transfer mechanism does not have a way to request a grant for corresponding UL resources for a response. As a result, when the DU 20 receives an RRC message from the CU 10 for which a response is to be sent by the UE 30, the UE 30 must initiate the grant process upon receipt of the RRC message, either through a scheduling request or through a RACH procedure, in order to acquire a grant for the resources to be used to send a corresponding UL message.

In contrast to the above, the CU 10 of system 100 can improve the efficiency of granting corresponding UL resources by including an indication, e.g., in the form of a “grant requested” information element (IE) and/or other means, in the DL F1AP message to the DU 20, which can enable the DU 20 to grant the corresponding UE UL resources without further intervention from the DU 20 or the UE 30. For instance, in addition to the DL RRC message directed to the UE 30, the DU 20 can also send an indication of pre-granted resources (e.g., in terms of time, frequency, etc.) that can be utilized by the UE 30 in sending its UL response. By piggybacking the grant request to the DL RRC message, such that the UE 30 does not need to go through scheduling request or RACH mechanisms to acquire resources to send the RRC response back to the CU 10 by way of the DU 20, the response time associated with DL RRC messages can be improved by avoiding the delays associated with the above and/or other mechanisms for resource acquisition between the DU 20 and UE 30. This can, in turn, increase communication speed between the UE 30 and the underlying communication network, reduce network congestion associated with additional resource request messaging, and/or provide other improvements to the performance of system 100 and/or a communication network in which system 100 operates.

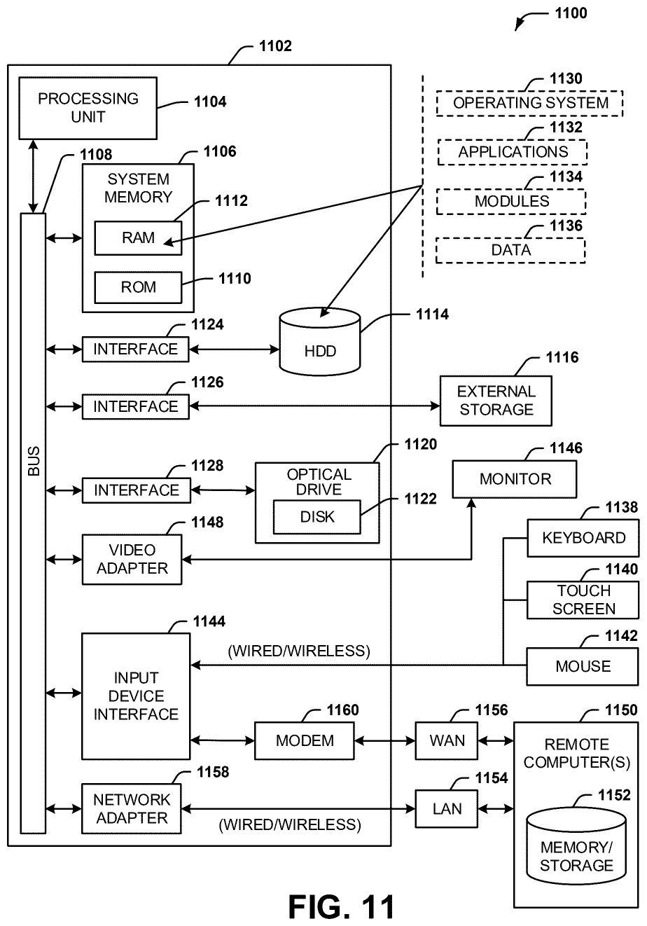

With further reference now to FIG. 1, the CU 10 of system 100 includes executable components, e.g., a scheduling coordinator 110, a message generator 120, and a transceiver 130, each of which can operate as described in further detail below. In an implementation, the components 110, 120, 130 of system 100 can be implemented in hardware, software, or a combination of hardware and software. By way of example, the components 110, 120, 130 can be stored on at least one memory (e.g., a memory 102) and executed by at least one processor (e.g., processor(s) 104). An example of a computer architecture including a processor and memory that can be used to implement the components 110, 120, 130, as well as other components as will be described herein, is shown and described in further detail below with respect to FIG. 11. As further shown in FIG. 1, the executable components 110, 120, 130, the memory 102, the processor 104, and/or other elements of the CU 10 can communicate with each other via a bus 106 and/or other components that provide intercommunication between various elements of the CU 10.

Additionally, it is noted that while the CU 10 is shown in FIG. 1 as a single device, the functionality of the respective components shown and described herein can be implemented via a single device and/or a combination of devices. For instance, in various implementations, the scheduling coordinator 110 shown in FIG. 1 could be implemented via a first device, the message generator 120 could be implemented via the first device or a second device, and the transceiver 130 could be implemented via the first device, the second device, or a third device. Also, or alternatively, the functionality of a single component could be divided among multiple devices in some implementations.

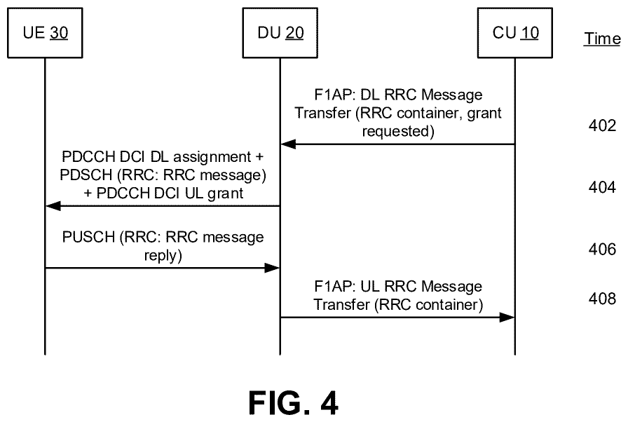

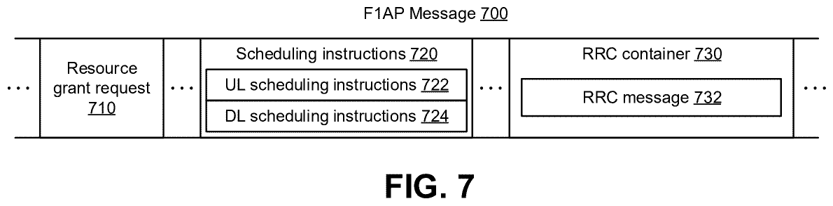

With reference now to the components of the CU 10 shown in system 100, the scheduling coordinator 110 can embed a resource grant request, for UL communication resources to be allocated (e.g., by the DU 20, as will be described in further detail below) for a response message to be transmitted by the UE 30 in response to a RRC message, into scheduling instructions associated with the RRC message. This resource grant request can at least partially take the form of a “grant requested” information element, e.g., as will be further described below with respect to FIGS. 4 and 7.

Based on augmented scheduling instructions with an embedded resource grant request as generated by the scheduling coordinator 110, the message generator 120 can generate a message, e.g., an F1AP message, that includes the RRC message and the augmented scheduling instructions generated by the scheduling coordinator 110. As further shown in FIG. 1, an F1AP message generated by the message generator 120 in this manner can then be transmitted, via a transceiver 130, to a DU 20 serving the UE 30.

In various implementations described herein, the F1AP message generated by the message generator 120 can take the form of an F1AP downlink RRC message transfer message, an example of which is described in further detail below with respect to FIG. 7. It is noted, however, that other message formats could also be used in some implementations. Additionally, while various examples provided herein relate to implementations in which the F1AP interface 22 between the CU 10 and DU 20 is a fifth generation (5G) new radio (NR) interface, it is noted that similar concepts to those described herein could also be applied to other types of interfaces and/or radio access technologies without departing from the scope of this description or the claimed subject matter.

Turning now to FIGS. 2-3, and with further reference to FIG. 1, various techniques for managing an RRC message exchange between a CU 10, a DU 20, and a UE 30 are illustrated. With reference first to FIG. 2, a communication flow for an RRC message exchange for a scenario in which the UE 30 is configured with scheduling request functionality is illustrated. By way of example, the UE 30 shown in FIG. 2 could be configured with scheduling request functionality during an RRC connection setup phase, which can occur prior to the communication flow shown in FIG. 2. By way of example, the UE 30 could be configured with scheduling request functionality according to one or more techniques generally known in the art, e.g., during a phase of RRC connection setup between SRB0 (signaling radio bearer 0) configuration and SRB1 configuration. Additionally, it is noted that configuring a UE 30 with scheduling request functionality can be an optional step, and that if the UE 30 is not configured with such functionality, the messaging flow could instead proceed as described below with respect to FIG. 3.

The flow shown in FIG. 2 starts at time 202, in which the CU 10 transmits an F1AP message, here a DL RRC message transfer message, containing an RRC container to a DU 20 serving a designated UE 30. The RRC container can include an embedded RRC message intended for the UE 30. By embedding the RRC message into an RRC container, the RRC message can be provided from the CU 10 to the UE 30 in a manner that is transparent to the DU 20. Next, at time 204, the DU 20 can forward the RRC message to the UE 30, e.g., as part of a data channel transmission on a physical downlink shared channel (PDSCH) and/or another suitable channel. As further shown at time 204, the DU 20 can provide the UE 30 with a DL scheduling assignment for downlink control information (DCI) messaging on a downlink control channel, e.g., a physical downlink control channel (PDCCH) or another suitable channel.

Because the UE 30 has previously been configured with scheduling request functionality, the UE 30 can initiate a scheduling request with the DU 20 at time 206, e.g., using a physical uplink control channel (PUCCH) and/or another suitable UL channel, for UL resources that can be used by the UE 30 for sending a response to the RRC message. At time 208, the DU 20 can receive the scheduling request from the UE 30, grant UL resources for the response, and send a grant to the UE 30 for the granted UL resources. As a result, the UE 30 can utilize the granted resources at time 210 to send an RRC message reply to the DU 20, e.g., on a physical uplink shared channel (PUSCH) and/or another suitable UL data channel. Lastly, at time 212, the DU 20 can containerize the RRC message reply and send an UL RRC message transfer message to the CU 10, e.g., over an F1AP interface, that includes the generated RRC container. In implementations, the structure of the RRC container sent at time 212 can be similar to that of the RRC container sent by the CU 10 to the DU 20 at time 202.

In the procedure shown in FIG. 2, the UE 30 acquires resources for transmitting an RRC message reply via the scheduling request and grant steps shown at times 206 and 208, respectively. However, this process introduces delay in transmitting the UL reply, e.g., associated with the amount of time taken by the UE 30 in initiating the scheduling request procedure, which can be variable based on UE implementation, as well as the amount of time taken by the scheduling request procedure itself.

Turning now to FIG. 3, an alternative communication flow that can be utilized for an RRC message exchange with a UE 30 that has not been configured with scheduling request functionality is illustrated. The communication flow shown in FIG. 3 can begin at times 302 and 304 by conveying an RRC message from the CU 10 to the UE 30 by way of the DU 20, e.g., in a similar manner to that described above with respect to time 202 and time 204 shown in FIG. 2.

At time 306, because the UE 30 in this scenario has not been configured to send scheduling request messaging, the UE 30 can instead acquire UL resources for sending an RRC response by sending a message (e.g., Message 1 as shown in FIG. 3) with a random access channel (RACH) preamble to the DU 20. At time 308, the DU 20 can receive the RACH preamble and determine based on the preamble that the UE 30 is requesting UL resources. As a result, the DU 20 can send a random access response to the UE 30, e.g., via PDSCH and/or another data channel, that contains the requested resource grant. In addition, the DU 20 can send additional signaling to the UE 30 at time 308, such as additional DCI scheduling parameters or other DCI-related information via PDCCH and/or another suitable DL control channel. Based on the granted UL resources, the UE 30 can then compose an RRC message reply, which can be sent back to the CU 10 via the DU 20 at times 310 and 312, e.g., in a similar manner to that described above with respect to times 210 and 212 shown in FIG. 2.

In the procedure shown in FIG. 3, the UE 30 acquires resources for transmitting an RRC message reply via a RACH procedure as shown at times 306 and 308, respectively. Similar to the scheduling request and grant steps shown in FIG. 2, this RACH procedure introduces delay in transmitting the UL reply, e.g., associated with the amount of time taken by the UE 30 in initiating the RACH procedure, which can be variable based on UE implementation, as well as the amount of time taken by the RACH procedure itself. Furthermore, the RACH procedure shown in FIG. 3 can encounter contention with RACH signaling transmitted by other UEs, which can further delay the RRC response.

In contrast to the procedures described above with respect to FIGS. 2-3, FIG. 4 illustrates a communication flow that can be utilized by the CU 10 shown in FIG. 1 to add a resource grant onto the F1AP message initially sent by the CU 10 to the DU 20 for an RRC message exchange. The procedure shown in FIG. 4 starts at time 402, in which the CU 10 sends an F1AP DL RRC message transfer message to the DU 20. In addition to the RRC container described above with respect to FIGS. 2-3, the message sent at time 402 further includes a “grant requested” flag, e.g., implemented via an information element IE in the F1AP message, that can inform the DU 20 to grant UL resources to the UE 30 for sending an RRC message reply without requiring any initiating actions by the UE 30 for those resources.

As a result of the “grant requested” IE sent by the CU 10 at time 402, the DU 20 can send signaling to the UE 30 at time 404 that includes the RRC message and corresponding DL assignment information, e.g., similar to that described above with respect to time 204 of FIG. 2 and time 304 of FIG. 3, along with a grant of UL resources to be utilized by the UE 30 in transmitting a reply. As a result, the UE 30 can transmit an RRC message reply to the DU 20 on the granted resources at time 406, which can be provided to the CU 10 at time 408, in a similar manner to that described above with respect to times 210 and 212 of FIG. 2 and times 310 and 312 of FIG. 3. In contrast to the procedures shown in FIGS. 2-3, however, FIG. 4 illustrates that the UE 30 can be pre-granted resources for sending the RRC message reply, thereby improving the response time for the RRC transaction by avoiding the delays associated with the scheduling request and/or RACH procedures shown in FIG. 2 and/or FIG. 3, respectively, before the resource grant can be sent to the UE 30.

In the examples shown by FIGS. 2-3, the DU 20 is unaware that the UE 30 has a need to send a responsive RRC message since the RRC messages provided to the DU 20 by the CU 10 are containerized such that they are transparent to the DU 20. In contrast, the CU 10 as shown in FIG. 4 can provide additional information to the DU 20 to indicate this need to the DU 20, which in turn can enable the DU 20 to provide a resource grant to the UE 30 without an explicit request for resources made by the UE 30.

Briefly returning now to FIG. 1, it is noted that the communication flows described above with respect to FIGS. 2-4 can be utilized for RRC message exchanges between a CU 10 and a UE 30 in which the UE is expected to provide a response back to the CU 10. For RRC signaling exchanges that do not require a response from the UE 30, such as RRC broadcast signaling to inform respective UEs 30 of timing information, RACH information, and/or other suitable RRC information, the CU 10 can send RRC signaling without a “grant requested” element, e.g., as described above with respect to FIGS. 2-3.

To state the above another way, for a first RRC message exchange that requires a response from the UE 30, the CU 10 can send a first F1AP message to the DU 20 that includes a grant request indication, e.g., as described above with respect to FIG. 4. Subsequently, for a second RRC message exchange that does not require a response from the UE 30, the CU 10 can send a second F1AP message to the DU that does not include a grant request indication, e.g., as shown at time 202 of FIG. 2 and/or time 302 of FIG. 3.

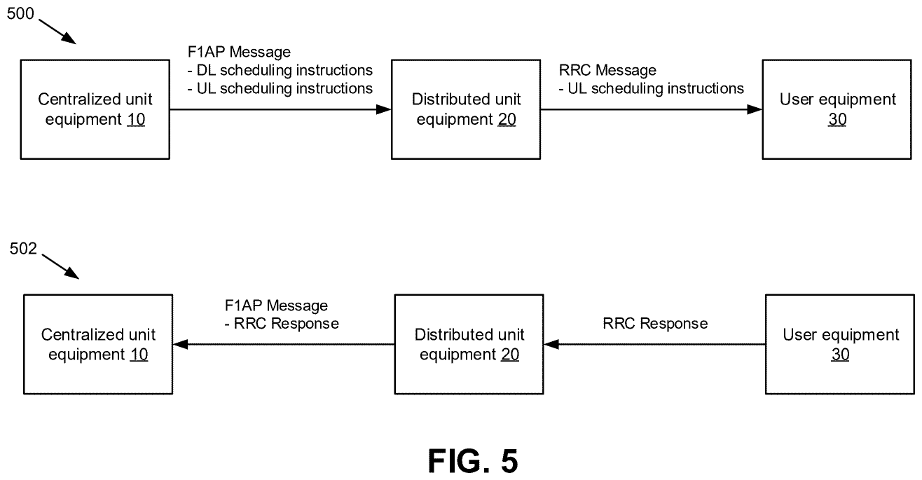

With reference now to FIG. 5, diagrams 500 and 502 illustrate an example flow of scheduling information that can be transmitted between a CU 10, a DU 20, and a UE 30 to facilitate an RRC messaging exchange. As shown first by diagram 500, an F1AP message sent by the CU 10 to the DU 20, e.g., an F1AP message generated by a message generator 120 of the CU 10 as described above with respect to FIG. 1, can include scheduling instructions of one or more types, such as UL scheduling instructions and DL scheduling instructions.

In an implementation, the DL scheduling instructions shown in diagram 500 can be associated with DL resource scheduling for transmission of an RRC message, e.g., an RRC message provided in an RRC container with the F1AP message, from the DU 20 to the UE 30. Also or alternatively, the UL scheduling instructions shown in diagram 500 can be associated with UL resource scheduling for transmission of a response message by the UE 30.

In the example shown by diagram 500, the F1AP message provided by the CU 10 to the DU 20 can include both UL and DL scheduling instructions, and the DU 20 can subsequently forward the UL scheduling instructions received by the CU 10, and/or other UL scheduling instructions, to the UE 30 with the corresponding RRC message to facilitate generation and transmission of a reply by the UE 30. While not shown in diagram 500, the DU 20 could also provide the DL scheduling instructions provided by the CU 10, and/or other scheduling instructions, to the UE 30 along with the illustrated UL scheduling instructions.

Subsequently, as shown by diagram 502, the UE 30 can generate a response to the RRC message and provide that RRC response to the DU 20 using the UL scheduling instructions provided to the UE 30 as shown in diagram 500. The DU 20 can then populate an RRC container with the RRC response and provide the RRC container back to the CU 10 in an F1AP message.

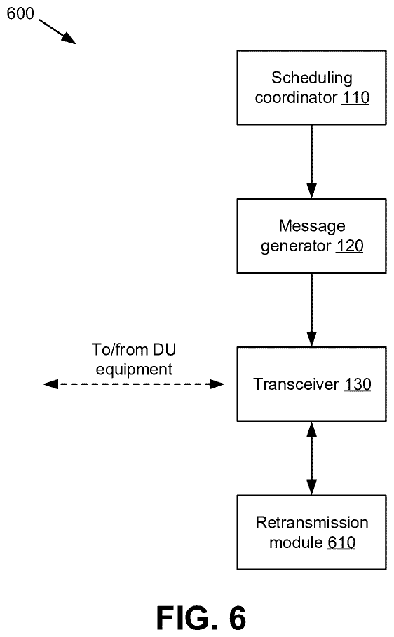

Referring next to FIG. 6, a block diagram of another system 600 that facilitates efficient resource grants for RRC messaging is illustrated. Repetitive description of like parts described above with regard to other implementations is omitted for brevity. System 600 as shown in FIG. 6 includes a scheduling coordinator 110, a message generator 120, and a transceiver 130, each of which can operate in a similar manner to that described above with respect to FIG. 1. While not shown in FIG. 6 for simplicity of illustration, system 600 can be implemented via a CU 10, e.g., a CU 10 configured as shown in FIG. 1, and/or other suitable devices. Similarly to that described above, e.g., with respect to FIG. 1, the transceiver 130 of system 600 can send an F1AP message to DU equipment (e.g., a DU 20), and the F1AP message can include a containerized RRC message for transmission to a UE 30. Subsequently, the UE 30 can transmit an RRC reply, which can be provided by the DU equipment back to the transceiver 130, e.g., in a similar manner to that shown in diagram 502 of FIG. 5.

In an implementation, the RRC message sent via the transceiver 130 to a UE 30 via associated DU equipment can specify a configuration action to be performed by the UE 30. By way of example, the RRC message could specify a transmit power to be used by the UE 30, a modulation and coding scheme (MCS) and/or other configuration properties to be adopted by the UE 30, and/or other suitable actions. To this end, a response received from the UE 30 by the transceiver 130 can indicate a result (e.g., success or failure) of that configuration action by the UE 30. In the event that the transceiver 130 does not receive a response from the UE 30, or a response is received that indicates that the UE 30 did not successfully complete the configuration action specified by the RRC message, system 600 (e.g., via a retransmission module 610 and/or other suitable components of system 600) can facilitate sending a repeat transmission of the RRC message to the UE 30, e.g., by repeating operation of the scheduling coordinator 110, message generator 120, and transceiver 130 as described above, until a response message received from the UE 30 indicates that the UE 30 has successfully completed the designated configuration action.

With reference now to FIG. 7, a diagram depicting an example F1AP message format that can be utilized in connection with one or more implementations described herein is illustrated. More particularly, FIG. 7 illustrates a simplified example of an F1AP message 700, e.g., an F1AP DL RRC Message Transfer message, that can be provided by a CU (e.g., CU 10 as shown in FIG. 1) to DU equipment serving a given UE. It is noted that the F1AP message 700 shown in 700 is not intended to represent a complete F1AP message, as an F1AP message could also contain one or more message components that are omitted from FIG. 7 for simplicity of illustration.

As shown in FIG. 7, the F1AP message 700 can include a resource grant request 710, which can indicate to destination DU equipment (e.g., the DU 20 shown in FIG. 1) that a resource grant for a reply to an included RRC message are requested. In an implementation, the resource grant request 710 can include a “grant requested” IE inserted into the F1AP message 700. A “grant requested” IE used in this manner can be an optional IE, e.g., such that it is only inserted into the F1AP message 700 if an RRC reply is expected. Additionally, such an IE can contain an identifier and/or other information, e.g., an identifier prepended to the IE and/or otherwise associated with the IE, that identifies the IE as containing the resource grant request 710.

As further shown in FIG. 7, the F1AP message 700 can contain scheduling instructions 720, including UL scheduling instructions 722 and/or DL scheduling instructions 724, that can be utilized to schedule resources for an RRC message exchange associated with the F1AP message 700, e.g., as described above with respect to FIG. 5. While the resource grant request 710 and scheduling instructions 720 are shown in FIG. 7 as separate message components, it is noted that the resource grant request 710 could, in some implementations, be implemented as part of the scheduling instructions 720. As additionally shown in FIG. 7, the F1AP message 700 can also include an RRC container 730, which can be used to carry an RRC message 732, e.g., an RRC message designated for a given UE 30 served by DU equipment to which the F1AP message 700 is directed, as described above.

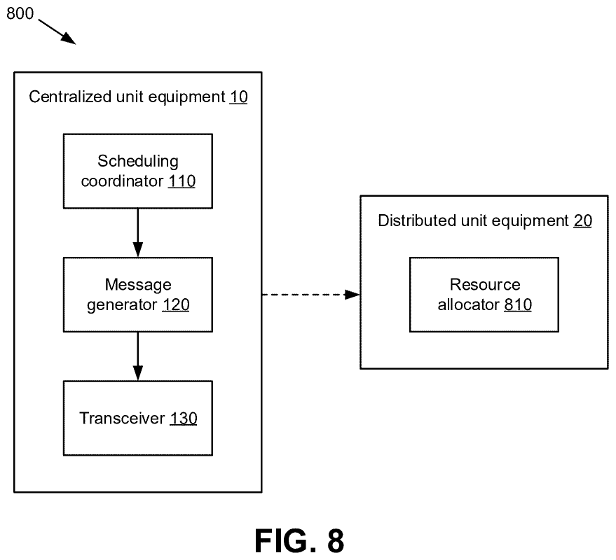

Turning next to FIG. 8, a block diagram of a further system 800 that facilitates efficient resource grants for RRC messaging is illustrated. Repetitive description of like parts described above with regard to other implementations is omitted for brevity. System 800 as shown in FIG. 8 includes a CU 10 with a scheduling coordinator 110, message generator 120, and transceiver 130 that can function as described above, e.g., with reference to FIG. 1, to facilitate sending an F1AP message with a resource grant request to a DU 20. As further shown by FIG. 8, an F1AP message provided by the CU 10 to the DU 20 can cause the DU 20 to allocate, e.g., via a resource allocator 810, the UL communication resources associated with a reply to the F1AP message, and/or otherwise facilitate allocation and/or scheduling of UL communication resources at the DU 20. Resources allocated and/or scheduled by the DU 20 in this manner can include, but are not necessarily limited to, a granted time slot for the response message, frequency resources granted for the response message, and/or other suitable resources.

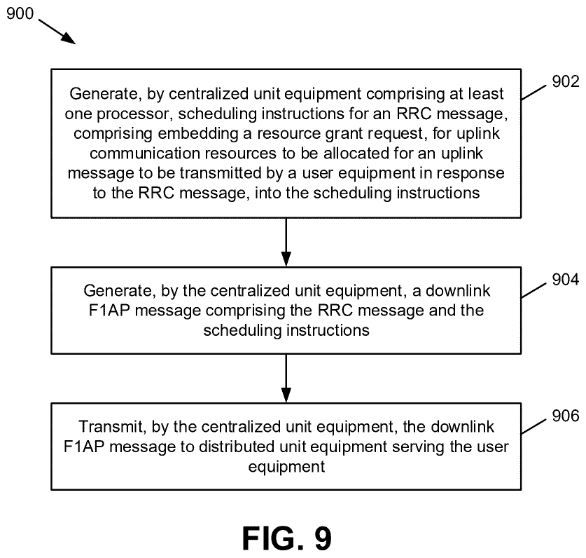

Turning to FIG. 9, a flow diagram of a method 900 that facilitates efficient resource grants for RRC messaging is illustrated. At 902, centralized unit equipment (e.g., CU 10) comprising at least one processor (e.g., a processor 104) can generate (e.g., by a scheduling coordinator 110) scheduling instructions for an RRC message. Generation of the scheduling instructions at 902 can include embedding a resource grant request, for uplink communication resources to be allocated (e.g., by a DU 20) for an uplink message to be transmitted by a user equipment (e.g., a UE 30) in response to the RRC message, into the scheduling instructions.

At 904, the centralized unit equipment can generate (e.g., by a message generator 120) a downlink F1AP message that includes the RRC message and the scheduling instructions generated at 902.

At 906, the centralized unit equipment can transmit (e.g., by a transceiver 130) the downlink F1AP message to distributed unit equipment (e.g., the DU 20) serving the user equipment.

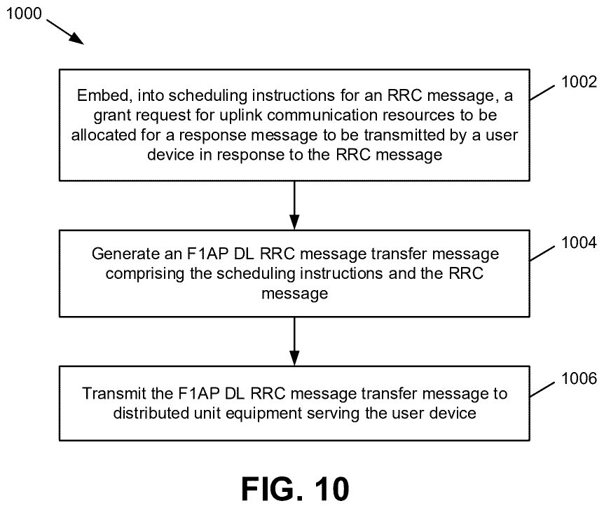

Referring next to FIG. 10, a flow diagram of a method 1000 that can be performed by at least one processor, e.g., based on machine-executable instructions stored on a non-transitory machine-readable medium, is illustrated. An example of a computer architecture, including a processor and non-transitory media, that can be utilized to implement method 1000 is described below with respect to FIG. 11.

Method 1000 can begin at 1002, in which the at least one processor can embed, into scheduling instructions for an RRC message, a grant request for uplink communication resources to be allocated for a response message to be transmitted by a user device in response to the RRC message.

At 1004, the at least one processor can generate an F1AP DL RRC message transfer message that includes the scheduling instructions and the RRC message.

At 1006, the at least one processor can transmit the F1AP DL RRC message transfer message to distributed unit equipment serving the user device.

FIGS. 9-10 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 11 and the following discussion are intended to provide a brief, general description of a suitable computing environment 1100 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
embedding a resource grant request, for uplink communication resources to be allocated for a response message to be transmitted by a user equipment in response to a radio resource control (RRC) message, into scheduling instructions associated with the RRC message, resulting in augmented scheduling instructions;
generating an F1 application protocol (F1AP) message comprising the RRC message and the augmented scheduling instructions; and
transmitting the F1AP message to distributed unit equipment serving the user equipment.

2. The system of claim 1, wherein the operations further comprise:
receiving, from the distributed unit equipment using the uplink communication resources as specified by the augmented scheduling instructions, the response message generated by the user equipment in response to the RRC message.

3. The system of claim 2, wherein the RRC message indicates a configuration action to be performed by the user equipment, and wherein the operations further comprise:
repeating the embedding, generating, transmitting, and receiving until the response message indicates that the user equipment has successfully completed the configuration action.

4. The system of claim 1, wherein augmented scheduling instructions comprise an information element of the F1AP message, the information element comprising the resource grant request.

5. The system of claim 4, wherein the generating of the F1AP message comprises prepending an identifier to the information element, the identifier identifying the information element as containing the resource grant request.

6. The system of claim 1, wherein the augmented scheduling instructions comprise scheduling instructions of a type selected from a group comprising a downlink scheduling type, associated with downlink resource scheduling for transmission of the RRC message from the distributed unit equipment to the user equipment, and an uplink scheduling type, associated with uplink resource scheduling for transmission of the response message by the user equipment.

7. The system of claim 1, wherein the operations further comprise:
facilitating allocating, by the distributed unit equipment, the uplink communication resources for the response message, the uplink communication resources being of at least one resource type selected from a group of resource types comprising a granted time slot for the response message and frequency resources granted for the response message.

8. The system of claim 1, wherein the F1AP message is an F1AP downlink RRC message transfer message.

9. The system of claim 1, wherein the transmitting comprises transmitting the F1AP message to the distributed unit equipment via a fifth generation new radio interface.

10. A method, comprising:
generating, by centralized unit equipment comprising at least one processor, scheduling instructions for a radio resource control (RRC) message, comprising embedding a resource grant request, for uplink communication resources to be allocated for an uplink message to be transmitted by a user equipment in response to the RRC message, into the scheduling instructions;
generating, by the centralized unit equipment, a downlink F1 application protocol (F1AP) message comprising the RRC message and the scheduling instructions; and
transmitting, by the centralized unit equipment, the downlink F1AP message to distributed unit equipment serving the user equipment.

11. The method of claim 10, further comprising:
receiving, by the centralized unit equipment from the distributed unit equipment, the uplink message using the uplink communication resources as allocated in response to in the scheduling instructions.

12. The method of claim 10, wherein the scheduling instructions comprise an information element of the downlink F1AP message, the information element comprising the resource grant request.

13. The method of claim 12, wherein the generating of the downlink F1AP message comprises applying an identifier to the information element, the identifier indicating that the information element contains the resource grant request.

14. The method of claim 10, wherein the scheduling instructions comprise scheduling instructions of a type selected from a group comprising a downlink scheduling type, associated with downlink resource scheduling for transmission of the RRC message from the distributed unit equipment to the user equipment, and an uplink scheduling type, associated with uplink resource scheduling for transmission of the uplink message by the user equipment.

15. The method of claim 10, wherein the F1AP message is an F1AP downlink RRC message transfer message.

16. The method of claim 10, further comprising:
facilitating, by the centralized unit equipment, allocation of the uplink communication resources for the uplink message by the distributed unit equipment.

17. A non-transitory machine-readable medium comprising computer executable instructions that, when executed by at least one processor, facilitate performance of operations, the operations comprising:
embedding, into scheduling instructions for a radio resource control (RRC) message, a grant request for uplink communication resources to be allocated for a response message to be transmitted by a user device in response to the RRC message;
generating an F1 application protocol (F1AP) downlink (DL) RRC message transfer message comprising the scheduling instructions and the RRC message; and
transmitting the F1AP DL RRC message transfer message to distributed unit equipment serving the user device.

18. The non-transitory machine-readable medium of claim 17, wherein the operations further comprise:
receiving, from the distributed unit equipment in response to the F1AP DL RRC message transfer message being successfully transmitted to the distributed unit equipment, the response signaling using the uplink communication resources indicated in the scheduling instructions.

19. The non-transitory machine-readable medium of claim 17, wherein the scheduling instructions comprise an information element of the F1AP DL RRC message transfer message, the information element comprising the resource grant request.

20. The non-transitory machine-readable medium of claim 17, wherein the scheduling instructions comprise scheduling instructions of a type selected from a group comprising a downlink scheduling type, associated with downlink resource scheduling for transmission of the RRC message from the distributed unit equipment to the user device, and an uplink scheduling type, associated with uplink resource scheduling for transmission of the response message by the user device.
